(19) United States
(12) Patent Application Publication
(10) Pub. No.: US 2014/0351052 A1
(43) Pub. Date: Nov. 27, 2014

(54) Contextual Product Recommendation Engine

(71) Applicants: Harbhajan S. Khalsa, Santa Fe, NM (US); Jonathan Repa, Santa Fe, NM (US)

(72) Inventors: Harbhajan S. Khalsa, Santa Fe, NM (US); Jonathan Repa, Santa Fe, NM (US)

(21) Appl. No.: 13/902,118

(22) Filed: May 24, 2013

(51) Int. Cl. G06Q 30/02

(52) U.S. Cl. CPC G06Q 30/0261; G06Q 30/0269
USPC 705/14.58

(57) ABSTRACT

Disclosed is a computer system that produces contextually relevant, customized and predictive product recommendations by combining a novel layered user interface and a server system implementing data mapping of one or more external product databases. The combining of these software of hardware components improves the quality and relevancy of product recommendations specifically when a user knows what they are interested in but not the products needed to accomplish these interests as well as when a user has more than one interest and wants product recommendations that take into account these multiple interests.

### BACKGROUND OF INVENTION

1. Field of the Invention

The present invention is a computer system that produces contextually relevant, customized and predictive product recommendations consisting of a software application implementing a novel layered user interface and a server system implementing data mapping of one or more external product databases. The user is able to specify one or more interests, be shown points of interest at which all or some of those interests may be productively pursued, and then be presented with recommendations for products that would help accomplish one interest or a combination of interests.

2. Description of the Prior Art

The problem of trying to provide computer system (web or mobile) users with relevant, customized and predictive product recommendations is well known within the fields of web and mobile e-commerce, software development, and marketing. Solutions are customarily grouped into three categories:

Content-Based Filtering:

These methods assign a set of discrete characteristics to each product, and predict a user's interest in particular products based on the similarity of their characteristics to products (or other information) the user has previously clicked on, purchased or viewed. Systems using this approach include the Pandora internet radio website (which chooses songs with characteristics similar to those of an initial song or artist selected by the user) and the Google AdSense advertising system (which chooses advertisements linked to keywords present in a user's Google search or email).

Collaborative Filtering:

These methods track the past shopping behavior of the user, and predict his or her interest in particular products based on the purchasing history of other users with similar behavioral profiles. Systems using this approach include Amazon.com (“Customers Who Bought This Item Also Bought . . . ”) and social networking sites such as Facebook (which classifies users according to a range of demographic factors and generates advertising customized by demographic).

Hybrid Filtering:

These methods are combinations of the two approaches described above, where the relative importance of product similarity and user similarity is weighted in an application-specific manner.

Where the prior art is limited is in providing product recommendations when a user has indicated interest in a particular activity but is not yet aware of the products needed to pursue that activity. Additionally, the prior art is limited in providing product recommendations when a user has multiple simultaneous interests.

### SUMMARY OF INVENTION

The present invention is a computer system that produces contextually relevant, customized and predictive product recommendations, consisting of a software system implementing a novel layered user interface (LUI) and a server system implementing data mapping of one or more external product databases.

The LUI allows the user to specify one or more interests and initiate a search for locations at which he or she may productively pursue those interests, herein referred to as points of interest (POIs). For each interest, the set of matching POIs is found and displayed, and grouped in a layer. POIs are displayed in a manner that clearly indicates to which layer(s) they belong. Layers can be selectively shown or hidden by the user.

The system then queries an external product database for products relevant to each POI. These products are ones that would support the user in the achievement of their interests at that POI or multiple POIs. Finally, product results are filtered using the user's account information and history.

It is therefore an object of the present invention to improve the quality and relevancy of product recommendations when a user knows what they are interested in, but not the products needed to accomplish these interests.

It is another object of the present invention to improve the quality and relevancy of product recommendations when a user has more than one interest simultaneously.

The present invention advances the state of the art by introducing a method for user specification of multiple interests and manipulation of the displayed query results (the LUI).

The present invention also advances the state of the art by introducing a system to execute such queries and recommend products to help a one achieve one's interest(s) when one does not know the products needed to achieve these interest(s). The present invention also advances the state of the art by introducing a system to execute such queries and recommend products to help a one achieve multiple interest(s) by recommending products that take into account not just one interest.

### BRIEF DESCRIPTION OF DRAWINGS

FIG. 1 is a diagram showing the software modules and hardware components required to build and operate the present invention.

FIG. 2 is a diagram showing the function of the LUI from the perspective of the user as a component of the present invention.

FIG. 3 is a diagram showing the software modules and resulting data sets illustrating how the present invention produces contextual product recommendations.

### DETAILED DESCRIPTION OF INVENTION

### 1. Definitions

Computing device as used herein shall mean a desktop computer, laptop computer, tablet computer, smartphone, mobile computer or other device on which it is possible to execute software.

Client as used herein shall mean the computing device operated by a user (e.g., customer).

Server as used herein shall mean a computer or set of computers, configured to communicate with many clients, transmit information to them, and perform tasks on their behalf.

Operating system as used herein shall mean the main software controlling a computing device, which supports the execution of all other software on the device.

Software module as used herein shall mean one of the pieces or components of the software, serving a particular function. Several modules working together, though potentially executing on different computer systems in different physical locations, constitutes a software application.

User interface as used herein shall mean the interactive aspects of the application that allow for operation and control of the application on the part of the user; and provide feedback which aids the user in making operational decisions and finding the information the user desires.

Web browser as used herein shall mean the software application on a client that allows the user to view web pages and execute web applications obtained from servers.

Web server as used herein shall mean a server configured to transmit web pages and web applications to clients.

Session as used herein shall mean a time-limited series of interactions between a client and server, generally to provide access to a specific set of web pages and web applications.

Session Token as used herein shall mean a number (generally very large) that identifies a session and has a well-defined expiration date and time. Used to verify whether interactions pertaining to a session should still be allowed.

Database as used herein shall mean a computer and/or software application that allows rapid storage, search, and retrieval of large quantities of information.

Cache as used herein shall mean a software module that stores previously obtained information for a well-defined, limited time period, to minimize repeated time-consuming requests for the same information.

Interest as used herein shall mean a need or desire of the user of the application, at varying levels of specificity. Examples of interests include the desire for a good restaurant for dinner this evening, the desire to go rock-climbing on a mountain of intermediate climbing difficulty, and the need for a retail store selling a particular product.

Point of interest (POI) as used herein shall mean a geographic or spatial location with features that may satisfy one or more interests as selected by a user. Examples of these features include natural or environmental features, retail businesses, and transportation access points.

Search space as used herein shall mean a geographic or spatial area within which the user requests the location of (and information about) points of interest.

Layer as used herein shall mean an abstraction representing the set of POIs within a search space that satisfies one or multiple interest(s) of the user.

Layered user interface (LUI) as used herein shall mean the aspects of the application with which the user interacts directly, and which support the use of layers, as defined above.

Data point as used herein shall mean any individual piece of information pertaining to a POI (e.g., zip code, business name, user rating).

Data mapping as used herein shall mean the process of assigning values to data points, POIs, and products in a specific context (in the presence of other POIs/data points and in relation to a particular user and his/her history), which supports ranking such items for quality and relevancy to the user's interests. This process involves integration of data points with detailed product data from external sources.

Map server as used herein shall mean a computer that provides remote access to a database of geographic or spatial data.

Amenities server as used herein shall mean a computer that provides remote access to a database of facilities, such as retail businesses and public services.

### 2. Best Mode of the Invention

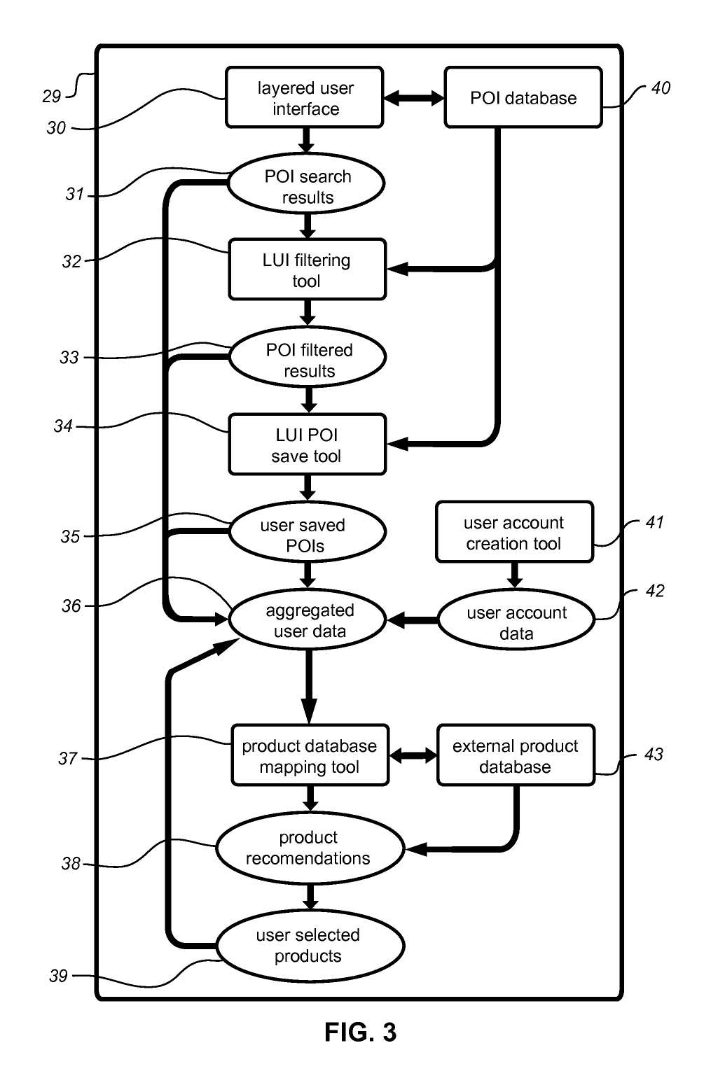

FIG. 3. shows one exemplary embodiment and the best mode contemplated by the inventor of the contextual product recommendation engine according to the concepts of the present invention.

### 3. How to Make the Invention

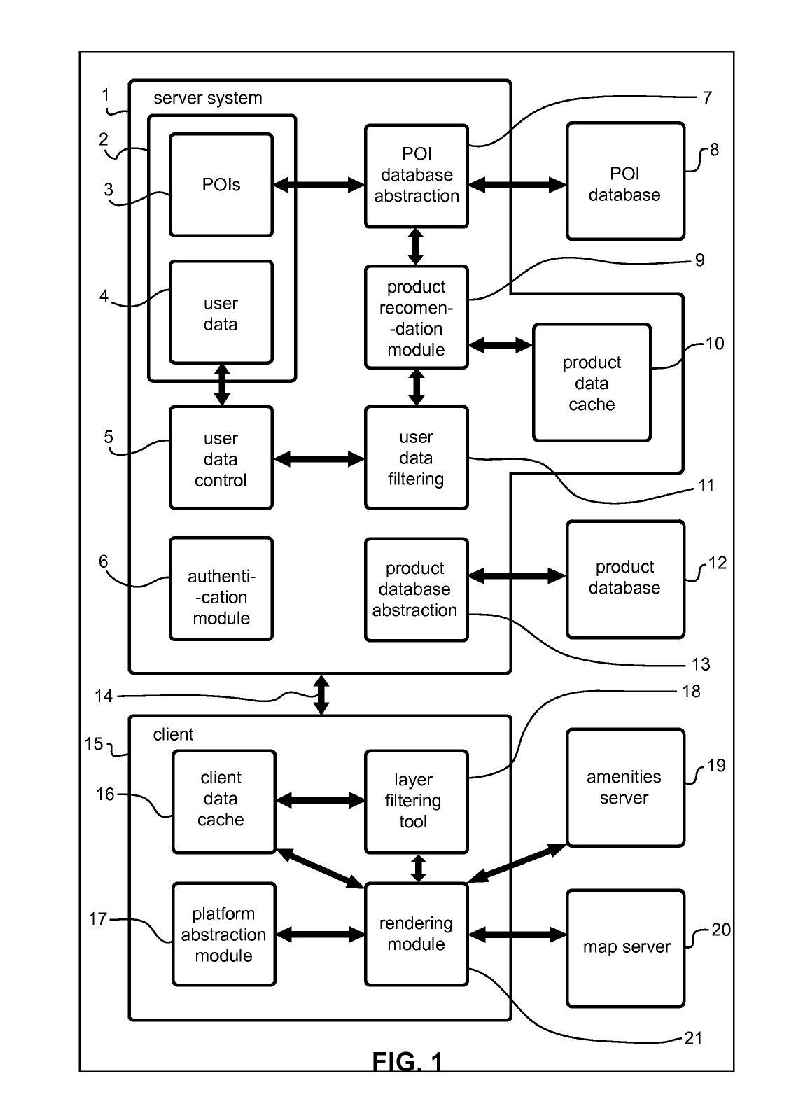

As indicated in FIG. 1 the contextual product recommendation engine is a system composed of multiple hardware components and software modules.

A server system 1 (consisting of one or more server computers) is configured as a web server and is also configured to hold and provide access to a database 2, which holds POI data as well as user account information and history.

Proprietary POI data 3 is stored into the database 2. Each POI consists of data points such as, but not limited to, title, geo-location, spatial location, description, images, videos, external links, user cumulative rating results, collective user views, and reviews. Each POI is classified by the interest category or categories to which it is conducive, interest-specific subcategories (e.g., skill level for sporting sites, cuisine type for restaurants, price point for products), and even more finely grained category- and subcategory-specific properties (e.g., suitability of a trail for cold-weather hiking as opposed to warm-weather hiking).

Connections are established between the server system 1 and one or more external map servers 20.

Connections are established between the server system 1 and one or more external amenities servers 19.

Connections are established between the server system 1 and one or more external product database servers 12. These servers provide detailed product information including, but not limited, to manufacturer, retail price, user ratings and reviews, and many of the category and subcategory specific information associated with POIs.

Optionally, a connection is established between the server system 1 and one or more external POI databases 8.

A software module, the product data cache 10, is installed on the server system 1. This module 10 implements a cache of external product data, to minimize the number of transactions performed on external databases 12 and maximize the responsiveness of the application to user commands.

A software module 13 is installed on the server system 1 which abstracts access to the external product databases 12, making them appear to the product data cache 10 as if they were a single database.

A software module 7 is installed on the server system 1 which abstracts access to the POI databases 8, making them appear to other modules as if they were a single database.

A software module, the authentication control module 6, is installed on the server system 1. This module 6 authenticates users and gives them access to the application. Upon authentication, this module 6 obtains a session token from the map server 20 and passes the token to the rendering module 21 of the user interface, which allows the rendering module 21 to directly obtain maps for the duration of the session.

A software module, the user data control module 5, is installed on the server system 1. This module 5 creates records 4 of information for each user and stores these records 4 in the database 2. This account data may include, but is not limited to, age, gender, location, interests, and previously viewed maps and POIs. This module 5 allows users to retrieve information they have previously viewed and grant access to this information to other users, if desired.

A software module, the product recommendation module 9, is installed on the server system 1. This module 9 performs data mapping on information from the external product databases 12 to generate a set of product recommendations for a given POI. First, it queries the databases 12 (via the product data cache 10 and product database abstraction module 13) for products that match one or more of the user's interests at the POI. Then, it evaluates the set of matches between the product's suitability characteristics and the category and subcategory classification of the POI. Each match is weighted by a coefficient obtained through user testing for the specific category and subcategory. The weighted terms are combined in an additive formula for computing a relevance rating.

A software module, the user data filtering module 11, is installed on the server system 1. This module 11 uses personal user records 4 to filter the set of products recommended by the product recommendation module 9. The relevance rating formula of a product is modified by adding terms computed by comparing product characteristics with the user's personal demographic information, as well as terms computed by comparing product characteristics with those of products the user has previously purchased. At the end of this process, the relevance rating formulas are evaluated, the products are sorted by relevance, and the set of products is truncated to a length appropriate for transmission to and display on the client.

A software module, the platform abstraction module 17, is installed on the server system 1 for transmission via the internet 14 to the user's computing device 15. This module 17 allows other modules 16, 18, 21 to access the capabilities of the user's computing device 15 without knowledge of the type of device, the operating system software executing on the device, or the web browser software executing on the device.

A software module, the client-side data cache 16, is installed on the server system 1 for transmission via the internet 14 to the user's computing device 15. This module 16 stores information about maps, POIs, and products that have been retrieved during the current session, in order to maximize the responsiveness of the application to user commands.

A software module, the rendering module 21, is installed on the server system 1 for transmission via the internet 14 to the user's computing device 15. This module 21 has the following functions: drawing an interface for POI display and filtering, with appropriate controls (such as checkboxes) for selecting and deselecting individual interests, categories of interests, and layers; drawing an interface for selection of a geographic or spatial region (e.g., by zip code, or by city and state, elevation); drawing maps, obtained directly from the map server 20; overlaying the maps with POIs, obtained from the POI database 3 via the server system 1; drawing popup windows containing additional detail about POIs and the names, textual details, and images of recommended products.

A software module, the layer filtering tool 18, is installed on the server system 1 for transmission via the internet 14 to the user's computing device 15. This module 18 interprets the user's commands (via mouse, keyboard, or touchscreen) as to which layers should exist and be shown, and instructs the rendering module 21 to draw these layers appropriately.

### 4. How to Use the Invention

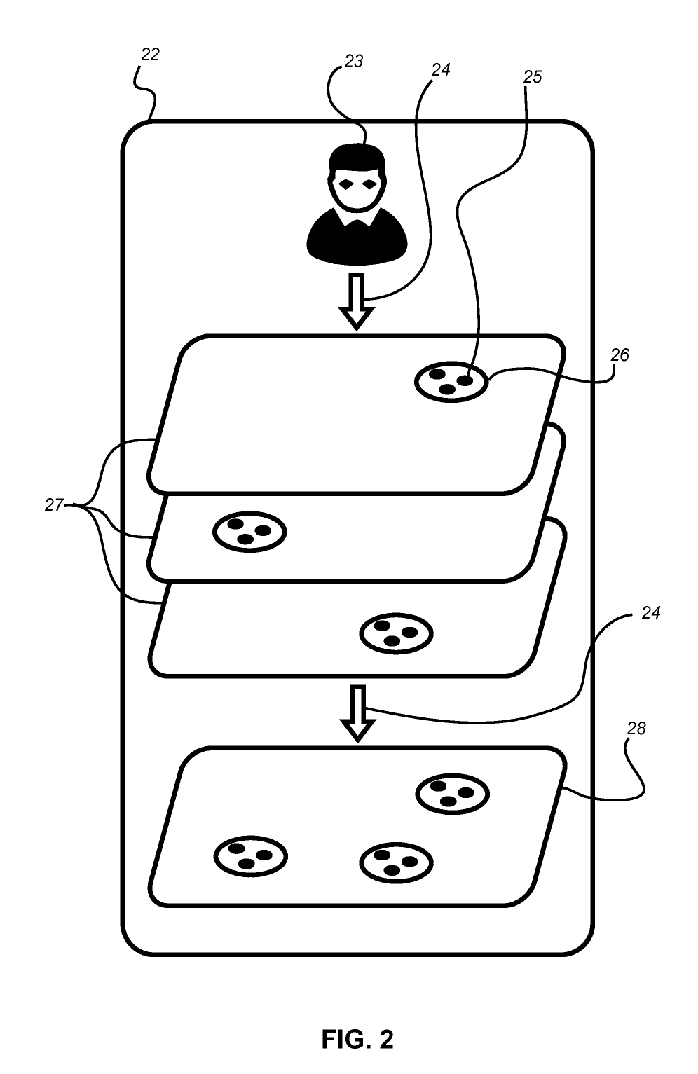

As indicated in FIG. 2 the layered user interface 22 provides a user 23 the ability to view one or more POI(s) 26 from one or multiple layer(s) 27 simultaneously. In addition the layered user interface 22 is designed to provide a user 23 with the ability to customize the resulting screen view 28 by selecting to view or not view each individual layer(s) 27 as well as one or more POI(s) 26 associated with each layer. From the view point 24 of a user 23, the resulting screen view 28 is determined by the layers(s) 27 and POI(s) 26 the user 23 selects to view or hide from view.

Each individual layer 27 may have one or more POI(s) 26 associated with it. All POI(s) 26 are made up of one or more data points 25. If a user selects to remove from view a layer 27 all POI(s) 26 associated with that layer will be non-viewable at that time as well. Within each individual layer 27, a user 23 may select to add or remove from view each individual POI 26 associated with that layer.

As indicated in FIG. 3 use of the contextual product recommendation engine 29 is characterized by a user's interactions with software modules and the resulting data sets. FIG. 2 illustrates the interactions between the software modules and the data sets to produce contextual product recommendations for a user. In FIG. 3 each data set is indicated by an oval and each software module is indicated by a rectangle with curved corners.

A software module, the layered user interface 29 provides the user the ability to search for POIs on multiple layers simultaneously.

The results of a search using a software module, the layered user interface 29 are collectively a data set, POI search results 31 and are sourced from a software module, the POI database 40.

The user can refine their search results using a software module, the LUI filtering tool 32. The results of refining search results using a software module, the LUI filtering tool 32 are collectively a data set, POI filtered results 33 and are sourced from a software module, the POI database 40.

At any time a user may remove individual POIs and save the remaining POIs using a software module, the LUI POI save tool 34. This action by the user will result in the user being prompted to create an account using a software module, the user account creation tool 41. The creation of a user account results in a data set, user account data 42. The user selected and saved POIs using a software module, the LUI POI save tool 34 are collectively a data set, user saved POIs 35 and are sourced from a software module, the POI database 40.

The data set, aggregated user data 36, is an aggregation of the following the data sets: POI search results 31, POI filtered results 33, user saved POIs 35 and user account data 42. If a user selects products from a data set, product recommendations 38, these selections will result in a new data set, user selected products 39 which will then be added to the data set, aggregated user data 36.

The software module, product database mapping tool 37 uses the data set, aggregated user data 36, to query a software module, external product database 43, to deliver product recommendations relevant to the data set, aggregated user data 36. From the user's perspective this happens in real time, that is say while the user is exploring, filtering down, removing individual POIs and saving groups of POIs using the software modules, layered user interface 30, LUI filtering tool 32 and the LUI POI save tool 34.

The problems addressed by the contextual product recommendation engine are many and significant as can be easily seen by those skilled in this art. The contextual product recommendation engine will improve the quality and relevancy of product recommendations when a user knows what they are interested in but not the products needed to accomplish these interests. The contextual product recommendation engine also improves the quality and relevancy of product recommendations when a user has more than one interest by means of the layered user interface. The contextual product recommendation engine also improves the ability of user to integrate data points related to multiple interests and suggest product selections based on this overlap of information. The contextual product recommendation engine will find wide spread use in the field of web and mobile e-commerce, website and mobile app development as well as marketers focused on these platforms because of it's innovative and effective approach to product recommendation.

### 5. Examples of the Invention

An example application of the present invention would be to help a user in the planning of outdoor activities and adventure sports, such as hiking, rock climbing, kayaking, etc. The user could select one or more such activity and a geographic point (zip code or municipality) on which to center the search; the search region could be expanded, contracted, or shifted at will. POIs related to the user selected activities would be located and displayed; such as trailheads, rock features, and river launches. Locations for amenities near the same geographic point (zip code or municipality), such as camping, lodging, and restaurants, can likewise be and found and displayed by the user. Next, products that aid in the selected activities at a particular POI, such as headlamps for night hiking, crampons for ice climbing, and activity specific backpacks, are displayed as a recommended product list for each POI. Each activity constitutes an interest, and the set of POIs matching that interest constitutes a layer. Each displayed amenity type and the associated amenity POIs also constitutes a layer. Selecting additional activities or deselecting previously selected activities shows or hides the corresponding layer of POIs, and causes the set of recommended products to be recomputed accordingly.

It will be appreciated by those skilled in the art that the present invention is not restricted to the particular preferred embodiments described with reference to the drawings and the example just given, and that variations may be made therein without departing from the scope of the present invention as defined in the appended claims and equivalents thereof.

What is claimed is:

1. A method of receiving product recommendations, comprising: selecting one or more interests and a geographic area to search; querying a map server for maps of the region; querying a point-of-interest (POI) database for sites at which the user may pursue his or her interests within the region; querying an amenities server for other sites supportive of the user's activities within the region; querying one or more product databases for products useful to support the user's combination of interests at the specific POIs found; ranking these products using a data mapping procedure and filtering the products to accord with the user's personal characteristics and usage history; presenting an interface which displays the maps, annotated with POIs and amenities sites; and displaying these product recommendations to the user.

2. A method of selecting one or more interests and viewing the obtained search results in a manner organized by interest, herein referred to as a layered user interface, comprising: displaying a set of interest categories and, when appropriate, subcategories of a broad activity domain; selecting one or more of the displayed categories and subcategories; presenting the resulting POIs in such a way that points which satisfy one particular user interest are grouped together into a layer.

3. The method according to claim 2, wherein POIs are displayed in a manner that clearly indicates to which layer(s) they belong.

4. The method according to claim 2, wherein the user may, upon being presented with results, select or deselect interest categories and subcategories, thereby instructing the application to display a particular layer, to prevent a particular layer from being displayed, or to compute and display additional layers.

5. The method according to claim 2, wherein the user may save maps with layers for future retrieval, modification, and sharing with other users.

6. A contextual product recommendation system capable of generating recommendations that satisfy one or more simultaneous user interests, comprising: a set of computers configured as a web server, with access to and control over internal databases, and with connections established to external servers; software modules, executable within a user's web browser, implementing the layered user interface described in claim 1, and stored on the server for transmission to the client upon user access; software modules, executable on the server, which manage user authentication and recordkeeping, communicate with and manage connections to internal and external databases and servers, and generate product recommendations relevant to the user and his or her selected POIs.

7. The system according to claim 6, wherein said internal databases include a set of POIs consisting of proprietary data points.

8. The system according to claim 6, wherein said internal databases include records of personal information volunteered by the user, history of user searches and other behavior, and layered maps generated in response to user requests and saved in response to user instruction.

9. The system according to claim 6, wherein said external connections include connections to servers providing geographic maps.

10. The system according to claim 6, wherein said external connections include connections to servers providing information about amenities available at or near specified geographic points.

11. The system according to claim 6, wherein said external connections include connections to servers providing information about retail products that may support user interests.

12. The system according to claim 6, wherein said external connections may include connections to servers providing access to databases containing additional POIs and data points.

13. The system according to claim 6, wherein said system contains a data mapping procedure supporting product recommendation to satisfy one or more user interests associated with a POI, based on available products in the external databases.

14. The system according to claim 6, wherein said system contains a user data filtering procedure supporting the filtering of product recommendations so as to suit the current user's personal characteristics and purchasing history.
